(19) United States
(12) Patent Application Publication
(10) Pub. No.: US 2007/0264421 A1
(43) Pub. Date: Nov. 15, 2007

(54) Method for Producing Multiple Layer Systems

(76) Inventors: Dieter Meier, Bad Nenndorf (DE); Raghbir Singh Bhullar, Indianapolis, IN (US)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(21) Appl. No.: 10/552,681

(22) PCT Filed: Apr. 7, 2004
(86) PCT No.: PCT/DE04/00732

§ 371 Date: Feb. 28, 2007

(30) Foreign Application Priority Data
Apr. 11, 2003 (DE) 103 17 046.4

(51) Int. Cl. B05D 5/12

(52) U.S. Cl. 427/124

(57) ABSTRACT

The invention relates to a method for producing multiple layer systems on a non-conductive substrate. According to said method, metallic layers and electrically non-conductive layers are alternately deposited respectively by means of PVD and PECVD and are modified in such a way that at least one layer can be optionally selectively structured. It was thus determined that selective structuring by means of laser energy is only possible by introducing sacrificial layers. In this way, for the first time, a miniaturisation of multiple layer systems can be achieved that is not possible with conventionally constructed multiple layer systems.

The invention relates to a method for producing multiple layer systems, which can be used in practice, for example, in order to produce sensors or also photovoltaic solar cells. Such multiple layer systems are configured for the most part as planar electrode systems, in which the insulation between individual electrodes formed by the electrically conductive layers is defined by the structuring methods and the electrical properties of the substrate.

In principle, here two basic forms are known, which differ through the arrangement of the conductive layers on the substrate. In the first basic form, the conductive layers are arranged exclusively on one side of the substrate. The precision of the conductor sections and the spacing between them are determined by the structuring methods. For the second basic form, the conductive layers are arranged on both sides of the substrate; their spacing and thus the insulation are determined by the material thickness of the substrate.

The use of the PVD method (Physical Vapor Deposition) to produce thin layers made from metals, their compounds, and alloys is the state of the art. The advantage of this method is that the layer materials form layers in a very pure state (large free path lengths of the residual gas in the HV or UHV range in thermal vaporization or the use of noble gases in cathode sputtering, the vacuum arc method, cylindrical cathode method, and ion-assisted method) and therefore form thick layers under suitable condensation conditions and condensation rates for a small layer thickness.

The PECVD method (Plasma Enhanced Chemical Vapor Deposition) involves the ionization and fragmentation of gaseous monomers in low-pressure plasma. The ionized monomers and their fragments can form layers, which adhere to suitably modified surfaces and whose molecular structure, however, is irregular and clearly three-dimensional in contrast to classical chemistry. This process, also designated as plasma polymerization, generates layers, whose properties for the same monomer can be influenced, among other things, by the variation of the gas mixture and the plasma intensity.

Polymers without or with slightly polar groups are suitable only conditionally for metallization. If one could use atmospheric methods (flaming, corona discharge) for the coating or the printing, the secondary effects of these techniques (roughening) would not be suitable for extremely thin layers. The activation of surfaces is a special application of plasma technology, which is used after the removal of latent layers (plasma cleaning). Here, activation means modification of the surface, which is necessary in order to achieve better adhesion of the layers to the substrate and also to each other. For activation processes with low-pressure plasma, in addition to argon, typically oxygen, but depending on the field of application also nitrogen or ammonia, is used. The duration of the activation processes usually equals only a few seconds. After the activation, the substrates are prepared for processing and are usually coated in the same installation.

Miniaturization, which, however, cannot be further improved with conventional methods, is a deciding factor in terms of the practical and scientific use of the multiple layer systems designed especially for technical sensors.

In addition to the production of such layers and multiple layer systems known from the state of the art, now the necessity arises of structuring such systems both individually and also layer-by-layer in order to guarantee full functioning in the application. Here, it can be assumed that the trend towards miniaturization will continue and structures <<50 μm are of interest.

In addition to known photolithographic structuring of such layers and layer systems, laser structuring has also become known. Thus, in DE 39 22 478 A1 a method is described, which wants to replace very non-environmentally friendly photochemical processes with more economical laser structuring. Thus, according to the invention a PMMA layer (polymethyl methacrylate), which is structured by an excimer laser, is deposited on a copper-coated polyimide material.

After the laser structuring, the known etching process is performed. In Patentschrift EP 0 281 843 B1, a method is proposed, which is also to enable the production of structures by means of laser processing. A Pd-bearing substance, which is ablated by the laser, is deposited on a conventional circuit-board material. The remaining Pd reacts catalytically without current in a Cu bath, so that layer construction can be performed additively.

Another possibility of the construction of structures under the use of laser technology is shown in patent EP 0 677 985 B1. Thus, recesses are generated by a laser (excimer) in an insulating carrier body. These recesses are made metallically conductive by PVD (Physical Vapor Deposition) and then can be reinforced electrolytically at a later time.

In DE 199 51 721 A1, a method is likewise described, in which, under the use of laser energy, thin metallic layers can be ablated in the nm range. Here, laser energy is in the position to penetrate the thin metallic layers and to break open the first molecular layers on the boundary to the polymer substrate material. Through the subsequent volume expansion (transition from solid to vapor state), the thin metal layer above is blown off and thus structured.

The object of the present invention is to create an economical method for producing multiple layer systems, which is in position to structure individual layers selectively in the complete composite by means of combining precisely tuned coating and structuring methods.

This object is achieved according to the invention with a method according to the features of claim 1. The subordinate claims involve especially useful refinements of the invention.

According to the invention, a method has become known, in which metallic layers by means of the PVD technique and electrically non-conductive layers by means of the PECVD technique are alternatively deposited on a substrate, wherein precise structuring of one or more layers is achieved through selective removal by using an intermediate organic layer (sacrificial layer).

According to the invention, it has been shown that this selective structuring can be performed only by means of a laser. Here, surprisingly it has been shown that the schematic arrangement of layers can be structured by means of a laser in an optimal way through the application of the intermediate layer as a sacrificial layer.

In this way, a sandwich structure, one metal layer followed by the electrically non-conductive layer as a dielectric and then another metal layer, is generated by PVD or CVD processes on, for example, a polymer substrate material. For the function, it is now necessary to structure individual layers selectively. This means that there is the possibility of reaching the dielectric selectively from the top metal layer. Furthermore, it is possible to reach the metal layer selectively from the metal layer.

This intermediate layer acting as a sacrificial layer enables, in particular, the removal of an (arbitrary) layer, which the laser energy penetrates essentially unimpaired, by means of a comparatively low energy input into the sacrificial layer below. Therefore, it succeeds in also removing layers, which are, in principle, unsuitable for laser ablation due to their material properties, such as is the case, for example, for ceramic layers consisting of MgO. Through the photon energy introduced into the sacrificial layer, chemical bonds are dissolved and the MgO layer above is ablated.

In this way, electronic multiple layers can be significantly reduced in size in that individual layers with extremely small layer thicknesses are realized through the combination of known methods according to the invention. Therefore, the resulting structuring enables, for example, the production of technical sensors with significantly reduced spacing between the electrodes. In this way, the necessary amounts of samples that must be introduced into the intermediate space of the electrodes in order to fill up these spaces are significantly reduced, so that materials that are only available in very small amounts can also be tested. In this way, the disposal costs of the samples can also be reduced, because the necessary volumes are reduced. The surprising insight of the present invention can be seen in that layers with a small layer thickness can be generated in comparison with the state of the art for miniaturization. As a result, the total thickness of the layer sequence is significantly smaller than the total thickness according to the state of the art of known multiple layer systems. By modifying the individual coatings, a homogeneous layer structure is achieved, which enables precise structuring and therefore reduces the size of the inner and outer dimensions.

Here, it has proven especially advantageous when the selective removal is performed by means of laser energy. In this way, previously unachievable structure dimensions can be realized, which also permit problem-free adaptation to the appropriate purpose. In a simple way, individual or several layers can be removed by means of laser energy and thus a desired surface quality, especially topography, can be generated. The structuring can be realized with low expense with the help of known methods.

Here, for practical and scientific purposes, multiple layer systems, in which the layer thickness of the non-conductive layers does not exceed 1 μm, are especially important in order to be able to realize previously unachievable miniaturization of industrial multiple layer systems, by means of which a plurality of new applications is enabled.

The layer structure of the multiple layer system could be realized uniformly over the entire surface. In contrast, a modification, in which the individual layers are also deposited on already structured layers, has also proven especially relevant to practice. In this way, the multiple layer system is not limited to a uniform layer structure, but instead also enables a layer structure tuned to special purposes with various layers in different areas of the multiple layer system. The first metallic layer is deposited in a plane and is optionally ablated selectively before the deposition of the non-conductive layer or is selectively deposited already onto the substrate in order to realize a 2 or 3-layer structure. The non-conductive layer adheres both to the substrate and also to the first metallic layer.

Another especially advantageous configuration of the method according to the invention is also then realized when the selective removal is performed by means of an ion-beam technique or an electron-beam technique in order to use the different processing parameters in an optimal way for the production of different multiple layer systems. Here, combinations of the various beam-removal methods are also possible in order to optimize, for example, the ablation or the structural dimensions accordingly.

Especially close to practice is a modification, in which the structuring is performed by selective removal exclusively of the second metallic layer. In this way, structuring of the outer metallic layer arises, in whose intermediate spaces formed by the removal, a medium to be tested can be introduced. Therefore, flat multiple layer systems with a high capacity can be realized, whose structural dimensions can be adapted, in particular, to the corresponding medium.

In another advantageous modification, in which the structuring is performed by selective removal of the second metallic layer and also of the electrically non-conductive layer, a notch is created in the multiple layer system, whose flanks are formed by the second metallic layer and also the non-conductive layer and whose base is formed by the surface of the first metallic layer. Through the first and second metallic layers formed as electrodes, in a simple way, for example, a filling level sensor or position sensor can be realized, which ideally can also be expanded by a measurement electrode that is only referenced to the second metallic layer in order to prevent, for example, measurement errors.

Furthermore, for an especially favorable embodiment of the invention, in which the structuring is performed through selective removal of the first metallic layer, the electrically non-conductive layer, and also the second metallic layer, a measurement electrode can also be realized, whose base is formed by the insulating substrate, so that, for example, the flanks of the notch can be wetted in order to be able to detect additional specific properties of the medium to be detected or the individual substance.

An especially good layer composite of the individual layers of the multiple layer system is achieved, in particular, by performing plasma activation before depositing the metallic layer or the electrically non-conductive layer. In this way, undesired separation of or damage to the layers is prevented even for high loading or aggressive environmental influences. The plasma activation enables optimal adhesion of the layers.

The substrate can consist of an arbitrary, non-conductive material, wherein, however, a modification, in which the substrate consists of polymer films, enables a flexible or shapeable multiple layer system.

The invention permits various embodiments. For further clarification of its basic principle, one of these embodiments is shown in the drawing and described below. Shown are:

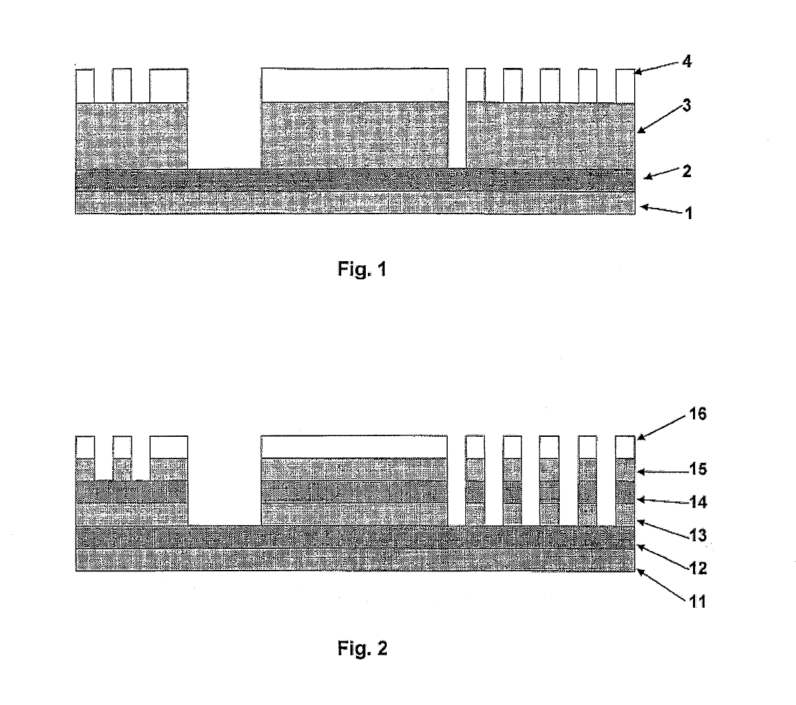

FIG. 1, a schematic of the structure of a multiple layer system;

FIG. 2, a schematic structure of another multiple layer system.

FIG. 1 shows schematically the structure of a multiple layer system and its requirements for the structuring. A sandwich structure, a metal layer 2 followed by an electrically non-conductive layer 3 as a dielectric and another metal layer 4, is generated on a polymer substrate material 1 by the mentioned PVD or CVD processes. For its function, it is now desired to structure individual levels selectively. This means that the possibility must exist to reach the dielectric 3 from the metal layer 4 selectively. Furthermore, the metal layer 2 can be reached from the metal layer 4 selectively. This sandwich arrangement can be repeated arbitrarily.

According to the invention, it has been shown that this selective structuring can be performed in a simple way by means of a laser. Here, surprisingly it has been shown that the schematic arrangement of layers shown in FIG. 1 can be structured by means of a laser in an optimal way by the use of an intermediate layer as a sacrificial layer.

This structure is described in more detail with reference to FIG. 2. A metallic layer 12 is deposited on a polymer substrate 11 by known PVD or CVD methods. Now an organic-based intermediate layer 13 follows as a sacrificial layer followed by the actual dielectric 14. Another organic-based sacrificial layer 15 follows. The metallic layer 16 forms the termination.

To produce the multiple layer systems, a Au layer as metallic layer 12 of 250 nm is deposited on the substrate 11 formed as a polyimide substrate with a layer thickness of 50 μm through vaporization. Then, through PECVD, a Teflon-like layer (CₓFy) with a layer thickness of 150 nm is laid on top as intermediate layer 13 or sacrificial layer. The actual dielectric 14 follows. This layer has a thickness of 600 nm and consists of MgO. Another intermediate or sacrificial layer 15 follows above this composite. It likewise consists of CₓFy. Then a Au layer follows as another metallic layer 16 of 50 nm. At a laser energy of 75 mJ/cm², selective ablation of individual layers with structure widths/structure spacings up to 50 μm could be achieved.

With reference to the same FIG. 2, a modified layer structure is described as an example.

The Au layer as metallic layer 12 of 500 nm is deposited on the substrate 11 configured as a polyimide substrate with a layer thickness of 75 μm through vaporization. Then, through PECVD, a Teflon-like layer CₓFy with a layer thickness of 150 nm is laid on top as intermediate layer 13. The actual dielectric 14 follows. This layer has a thickness of 300 nm and consists of SiO. Another layer as intermediate layer 15 follows above this composite. It likewise consists of CₓFy. Then a Au layer of 50 nm follows as additional metallic layer 16. At a laser energy of 120 mJ/cm², selective ablation of individual layers with structure widths/structure spacings up to 20 μm could be achieved.

Likewise, the layer structure below can be realized. A Au layer of 250 nm as metallic layer 12 is deposited on a substrate 11 configured as polyester with a layer thickness of 1 μm through vaporization. Then, through PECVD, a Teflon-like layer CₓFy with a layer thickness of 200 nm is laid on top as intermediate layer 13. The actual dielectric 14 follows. This layer has a thickness of 150 nm and consists of MgF₂. Another intermediate layer 15 follows above this composite. It also consists of CₓFy. Then a Au layer follows as metallic layer 16 of 80 nm. At a laser energy of 90 mJ/cm², selective ablation of individual layers with structure widths/structure spacings up to 20 μm could be achieved.

1-11. (canceled)

12. A method for manufacturing a test sensor, comprising:
forming a multiple layer device, including depositing a metallic layer onto a substrate material by physical vapor deposition, and depositing an electrically non-conductive layer adjacent said metallic layer by plasma enhanced chemical vapor deposition; and
applying an amount of laser energy to said multiple layer device to selectively remove a portion of said intermediate layer and a corresponding portion of either said metallic layer or said non-conductive layer.

13. The method of claim 12 in which said depositing an electrically non-conductive layer comprises depositing an intermediate layer on said metallic layer, and depositng said electrically non-conductive layer on said intermediate layer.

14. The method of claim 13, wherein said amount of laser energy is in the range of approximately 40 mJ/cm² to 450 mJ/cm².

15. The method of claim 13, wherein said laser energy includes an ion-beam.

16. The method of claim 13, wherein said laser energy includes an electron beam.

17. The method of claim 13, wherein the metallic layer includes at least one of copper, silver, gold, platinum, palladium, nickel, or aluminum.

18. The method of claim 13, wherein the electrically non-conductive layer has a thickness less than or substantially equal to 1 μm.

19. The method of claim 13, wherein the intermediate layer is made of polytetrafluorethylene.

20. The method of claim 19, wherein the intermediate layer is deposited onto said metallic layer by plasma enhanced chemical vapor deposition.

21. The method of claim 13, wherein the substrate is made of a polymer material.

22. The method of claim 21, wherein the substrate is flexible.

23. The method of claim 13, further comprising:
depositing at least one of a second metallic layer, a second intermediate layer, or a second non-metallic conductive layer on said multiple layer device.

24. The method of claim 13, further comprising:
removing said corresponding portion of said non-conductive layer.

25. The method of claim 13, further comprising:
performing plasma activation before depositing said metallic layer, said non-conductive layer, or said intermediate layer.
